(19) United States
(12) Patent Application Publication
(10) Pub. No.: US 2011/0045362 A1
(43) Pub. Date: Feb. 24, 2011

(54) OXIDATION-RESISTANT COMPOSITE CONDUCTOR AND MANUFACTURING METHOD FOR THE COMPOSITE CONDUCTOR

(75) Inventors: Andreas REINERT, Dresden (DE); Jõrg Brabandt, Dresden (DE); Daniela Sehm, Dresden (DE)

Correspondence Address: FITCH, EVEN, TABIN & FLANNERY, P. O. BOX 18415, WASHINGTON, DC, 20036, US

(73) Assignee: Staxera GmbH, Dresden (DE)

(21) Appl. No.: 12/828,740

(22) Filed: Jul. 1, 2010

(30) Foreign Application Priority Data
Aug. 24, 2009 (DE) 10 2009 038 693.9

(51) Int. Cl. H01M 8/02; H01B 5/00; H02G 15/20; H01B 13/22; B23K 31/02

(52) U.S. Cl. 429/400; 174/126.2; 174/24; 174/77 R; 156/52; 228/101

(57) ABSTRACT

A composite conductor for electric current comprises a core made of a first material and a jacket made of a second material, wherein the second material has a lower electrical conductivity than the first material. The second material is oxidation-resistant at temperatures up to at least 600° C., in particular at temperatures up to at least 800° C., in particular at temperatures up to at least 900° C. A fuel cell system comprises at least one fuel cell, to which a composite conductor according to the present invention is connected. A manufacturing method for a composite conductor comprises following steps: Provision of a core made of a first material and encasing the core by a second material having a lower electrical conductivity than the first material. The second material is oxidation-resistant at temperatures up to at least 600° C., in particular at temperatures up to at least 800° C., in particular at temperatures up to at least 900° C.

The invention relates to a composite conductor for electric current, wherein the composite conductor comprises a core made of a first material and a jacket made of a second material, wherein the second material has a lower electrical conductivity than the first material.

Furthermore, the invention relates to a fuel cell system having a least one fuel cell.

In addition, the invention relates to a manufacturing method for a composite conductor, wherein the manufacturing method comprises following steps: Providing a core of a first material and encasing the core by a second material, which has a lower electrical conductivity than the first material.

Electrical resistivities of many materials used as electric conductors increase with temperature. Furthermore, at operation conditions of solid oxide fuel cells (SOFC) some good conductors reach their limits of mechanical strength and corrosion. Therefore, as conductors high-temperature-resistant materials are used today, which have a very high specific electrical resistivity compared to usual conductor materials and thus contribute significantly to Ohmic losses. With fuel cell systems having a few kW power, the Ohmic loss may amount to several percent. To counteract this, [the size of] the cross-sections of current-carrying conductors may be increased, this however increases system weight and material costs.

EP0496367B1 describes a conventional temperature- and oxidation-resistant composite conductor having a core conductor, an intermediate layer, and an outer layer. The core conductor is made of copper, the intermediate layer is made of an electroconductive material of titanium boride and carbon, and the outer layer is made of nickel. Because an oxidation of the nickel is not negligible at temperatures above 500° C., it is proposed to coat the outer layer of nickel by an oxidation-inhibiting ceramic layer, to prevent the layer of nickel from oxidizing. The build of the three layers of materials around the core conductor is expensive to manufacture.

It is an objective of the present invention to provide a conductor for electrical current, wherein the conductor can be manufactured at lower expenses and wherein the conductor is oxidation-resistant at temperatures up to at least 850° C.

The conventional composite conductor described in EP0496367B1 leads to rise in costs of manufacturing a fuel cell system, when the conventional composite conductor is used for this purpose.

Consequently, it is also an objective of the present invention to provide a fuel cell system which can be manufactured more cost-efficiently.

Furthermore, it is an objective of the invention to provide a method for manufacturing the composite conductor.

This objective is reached by the features of the independent claims. Beneficial embodiments of the invention are defined in the dependent claims.

The invention is based on a generic composite conductor [of prior art] in that the second material is oxidation-resistant at temperatures up to at least 600° C., in particular at temperatures up to at least 800° C., in particular at temperatures up to at least 900° C. Hereby, in comparison to the conventional composite conductor, manufacturing expenses for the additional outer non-oxidizing layer are saved.

In a preferred embodiment of the device, a gas-filled gap is arranged at least sectionally between the core and the jacket, in particular along a prevailing portion of the length of the core. Hereby, a mechanical overload or fatigue of the components of the composite conductor as a result of different thermal expansions of jacket and core can be avoided.

Further, there is a benefit when the second material comprises temperature-resistant steel or a nickel-base alloy. Such materials have an elasticity, which is sufficient and checkable, such that an unexpected break of the jacket during an operation of the fuel cell system can be ruled out. Furthermore, these materials can contribute beneficially to the conductance of the composite conductor or to the minimization of weight of the composite conductor, respectively, because these materials have a conductivity not to be neglected.

In a further preferred embodiment of the device, the second material comprises X15CrNiSi25-20 or X1CrTiLa22 or NiCr15Fe. These materials are obtainable with reasonable effort and processible with reasonable effort.

In an advanced development of the device the second material is a ceramic, in particular aluminium oxide or zirconium oxide. These materials are also obtainable with reasonable effort and processible with reasonable effort.

In a further preferred embodiment of the device, the first material comprises a semiconductor, a metallic alloy, or a metal, in particular copper, nickel, or silver. These materials have a significant higher conductivity than the second material for the jacket and are also obtainable with reasonable effort and processible with reasonable effort.

In an embodiment of the device, the core is prevailingly or completely air-tightly enclosed with help of the jacket. The air-tight termination allows to prevent oxygen from the atmosphere to reach areas of the core having a high temperature and consequently being particularly at risk of corrosion in the presence of oxygen.

Furthermore, it may be beneficial for the composite conductor to be completely enclosed by the jacket.

Furthermore, it is possible that the core is freely accessible at one ending of the composite conductor. The composite conductor may have an unsymmetrical build by having a first ending, which is designed to be connected to the fuel cell, and by simultaneously having a second ending, which is designed to be connected to a consumer [of electricity]. The ending of the composite conductor which is not designed to be connected to the terminal of the fuel cell has a lower risk of corrosion, because here no such high temperatures occur as in the direct neighbourhood of the fuel cell. Therefore, the core at the ending of the composite conductor without risk of corrosion may be passed through the jacket at a location, where the core is already sufficiently cooled down. The core should be enclosed in the jacket along such an axial length that the core, in spite of its excellent conductivity, has been sufficiently cooled-down up to the place of outlet through the jacket. The accessible free ending of the composite conductor has the advantage that the current can be tapped directly from the current-carrying core, having a high conductivity, with minimal transitional resistance and minimal contact risk. Further, the core can be carried out as a core of a flexible connection cable, wherein the cable may be installed to a consumer or into a consumer [of electricity]. Then, the composite conductor forms a portion of the terminal cable, which is temperature-resistant in a head area. The core of the composite conductor may be a head portion of a strand of a flexible connection cable.

At one or both endings of the jacket, a respective seal may be arranged between the jacket and the core. The seal at the first ending of the composite conductor may be a high-temperature-resistant seal. For the seal at the second ending of the composite conductor at least one of following may apply: The seal is also a high-temperature-resistant seal; the seal is made of silicone or of rubber. By means of the seal the reliability can be increased that no oxygen from the atmosphere intrudes into the gap between jacket and core.

For the composite conductor at least one of following may apply: The composite conductor may be enclosed air-tightly at a first ending of the composite conductor by a first end sleeve made of a third material; the composite conductor may be enclosed air-tightly at a second ending of the composite conductor by a second terminal sleeve made of a fourth material. The terminal sleeve may have a formation (at least one of a build, a form, and a surface condition) adapted to a terminal of the fuel cell or to a terminal of the consumer, respectively. For example, the end sleeve may have at least one of a contact lug and a spring-like snap-lock part.

The fourth material may belong to the group of materials of the first material. The fourth and the first materials may be equal. Hereby, a risk of forming of transitional resistivities resulting from electro-chemical reactions is reduced.

At least one of the third and the fourth materials can belong to the groups of materials of the second material. At least one of following may apply: The second and third materials are equal; the second and the fourth materials are equal; the third and the fourth materials are equal.

At one or both endings of the composite conductor, the respective end sleeve may be joined to the jacket or to the core by at least one of welding, rolling over, and grouting. Hereby, a reliable mechanical and electrical connection with the end sleeve can be created.

Further, it is possible, that the composite conductor including its terminals does not have an end sleeve. Hereby, the reliability can be increased and the number of parts, the fitting work, and the weight of equipment can be reduced.

At one or both endings of the composite conductor, the jacket may be joined to the core at least by one of welding, rolling over, and grouting. Hereby, at the respective ending between jacket and core, a reliable mechanical and electrical connection can be created.

The invention builds on a generic fuel cell system [of prior art] in that a composite conductor according to the present invention is connected to the at least one fuel cell.

The invention builds on the generic manufacturing method [of prior art] in that the second material is oxidation-resistant at temperatures up to at least 600° C., in particular at temperatures up to at least 800° C., in particular at temperatures up to at least 900° C.

In an embodiment of the method, when encasing the core, a gas-filled gap is left at least sectionally between the core and the jacket, in particular along a prevailing portion of the length of the core.

In a further embodiment of the method, at one or both endings of the composite conductor, the jacket is joined to the core, after the step of encasing the core, by at least one of welding, rolling over, and grouting.

In an also preferred embodiment of the method, at one or both endings of the composite conductor, a respective end sleeve is joined to the jacket or the core, after the step of encasing the core, by at least one of welding, rolling over, and grouting.

Now, the invention is explained by examples with reference to the accompanying drawings with help of particularly preferred embodiments:

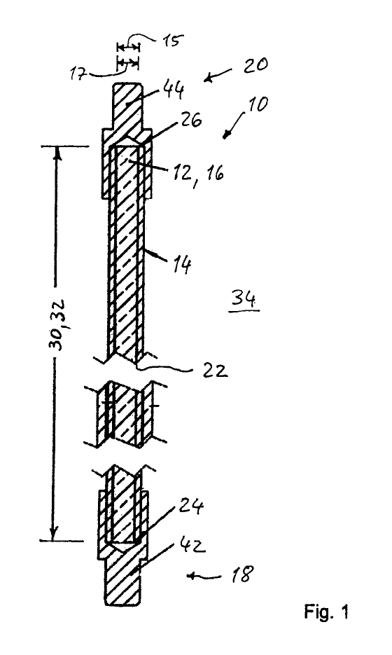

FIG. 1 shows schematically in a longitudinal cross-section the build of a composite conductor having two end sleeves;

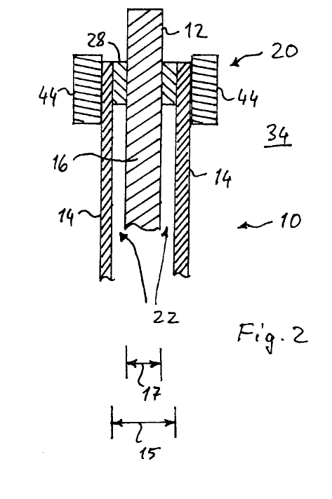

FIG. 2 shows schematically in a longitudinal cross-section an ending of the composite conductor, wherein at the ending a seal is arranged between jacket and core;

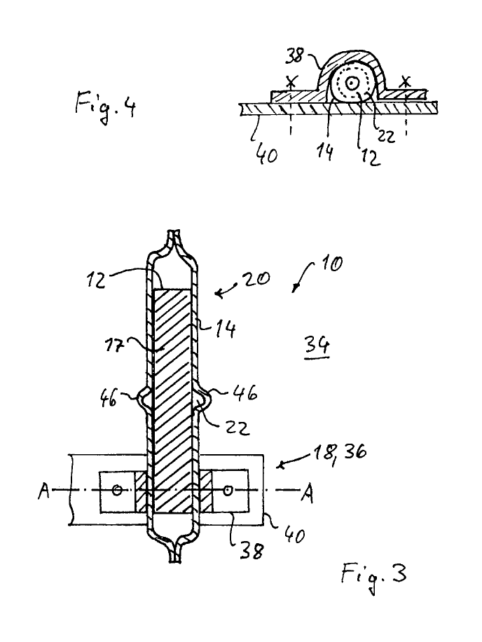

FIG. 3 shows schematically in a longitudinal cross-section the build of a composite conductor, wherein its jacket encloses the core gas-tightly;

FIG. 4 shows schematically in a cross-section along section line A-A of FIG. 3 the build of an electrical terminal of the composite conductor, wherein its jacket encloses the core gas-tightly; and

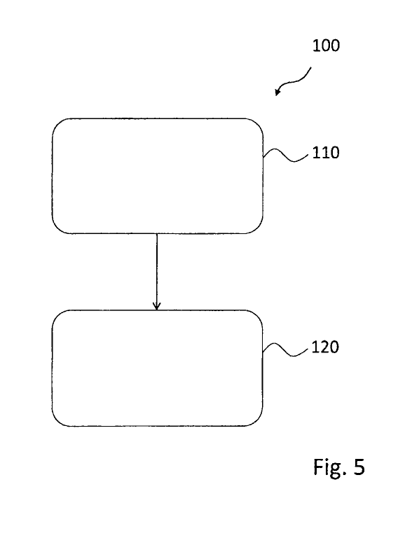

FIG. 5 shows schematically a flow of a manufacturing method for a composite conductor.

The composite conductor 10 shown in FIG. 1 may, for example, be used for connecting a terminal pole of an SOFC fuel cell stack to a terminal pole of an inverter. This may be done by screwing-on or welding-on of an ending 18, 20 of the composite conductor 10 to a terminal pole of the fuel cell stack or of the inverter, respectively. Typically, the composite conductor 10 is passed through a ceramic insulation (heat shield of the fuel cell stack). During the operation of the fuel cell stack, the ending 18 of the composite conductor 10 close to the fuel cell is exposed to a temperature of about 850° C. The other ending 20 of the composite conductor 10 is arranged in a several hundred degrees colder area, which has, for example, a temperature of 60° C. A length of the composite conductor 10 is for example between 250 and 400 mm. The outer diameter of the core 12 is, for example, 3.8 mm, and the inner diameter of the jacket is for example 4 mm. Consequently, a gap 22 of 0.1 to 0.2 mm is designed. The composite conductor 10 comprises a rod-shaped core 12 having a high specific conductivity. Typically, the core 12 has a circle-shaped or a ring-shaped cross-section or a cross-section having the shape of a regular polygon, for example of a hexagon. Furthermore, the composite conductor 10 comprises a substantially tube-shaped jacket 14, completely enclosing the core 12 at its lateral surface 16 or its lateral surfaces 16, respectively.

The core 12 is made of a first material, and the jacket 14 is made of a second material. The first material has a higher conductivity than the second material, is, however, not such oxidation-resistant as the second material. For the core 12 copper, nickel, or silver may be used, for example. As material for the jacket 14 heat-resistant iron-chromium-nickel materials, ferritic chromium steels, or nickel-chromium-iron alloys, in particular the steels 1.4841 (Cronifer® 2520) or 1.4760 (Crofer 22 APU®), or 2.4816 (Inconel® 600), respectively, are suitable, for example. Ceramics, like aluminium oxide or zirconium oxide, may also be used for the jacket 14. Before the assembly with the core 12, an inner diameter 15 of the jacket 14 can be selected which is a little larger than the outer diameter 17 of the core 12. At low temperatures (of for example not over 60° C.) before or after connecting with the core 12, the endings 14a, 14b of the jacket 14 can be permanently compressed. Thereby, the jacket 14 is slightly bulge-shaped at low temperatures, such that between the endings 18, 20 an air-filled gap 22 is left. The assembly can take place under a protective gas, such that after the assembly, the gap 22 is filled with the protective gas (for example a welding protective gas, nitrogen, a noble gas, or carbon dioxide, or a composition from these gases). There can be circumstances under which it may be acceptable that at the assembly of the jacket 14 and core 12 a portion of oxygen stays in the gap 22, wherein the portion of oxygen is used up after a heating up of the composite conductor 10 by means of oxidation of an outer layer of the core 12. A gas-tight closure of the transition between jacket 14 and core 12 can take place simultaneously with the pressing (for example by grouting or rolling over), or in a further process step (for example during manufacture of a welding seam 24, 26). For welding, a tungsten-inert-gas welding (TIG), a metal active gas welding (MAG), or gas welding [autogenous welding] may be considered. Depending on the applied welding method, for the welding-on of the jacket 14 and of the end sleeve 42, 44, respectively, SG-NiCr20Nb (2.4806) may be used as welding wire, as long as material 2.4816 (Inconel® 600) is used for the jacket 14 or the end sleeve 42, 44, respectively. During or after the assembly of jacket 14 and core 12 a seal 28 may be arranged between the jacket 14 and the core 12. In particular, for the ending 18 of the composite conductor 10 close to the fuel-cell, a seal 28 made of a soft metal alloy may be provided, which is temperature-resistant. Typically, a specific coefficient of thermal expansion of the first material is higher than that of the second material. Therefore, a length 30 of the core 12 will increase more at temperature increase up to for example 850° C. than a length 32 of the jacket 14. The gap 22 and the shape of the jacket 14, which is slightly abdomen-like as described before, may provide tolerance for at least a partial compensation of the length difference resulting from the temperature increase. Alternatively or in addition, the jacket 14 may be compressed a little before the assembly with the core 12 such that one or more bellows 46 are formed along its length 32 facilitating a non-destructive and fatigue-proof expansion of the jacket 14. Further, by means of the seal 28 mentioned before an alternative or additional possibility for a compensation of the different length expansions can be created. When designing the size of the gap 22, it may be considered that, resulting from the gas-tight termination 24, 26 and from the temperature increase, a partial pressure is built up between the surrounding area 34 of the composite conductor 10 and the gas in the gap 22.

At the junctions at the endings 18, 20 of the composite conductor 10 there must be an electrical connection to the well-conducting core 12. FIG. 1 shows a composite conductor 10 having one conducting end sleeve 42, 44 at each ending of the composite conductor 10. If both end sleeves 42, 44 are made of a temperature-resistant and oxidation-resistant material, in particular if the end sleeves 42, 44 are made of a same temperature-resistant and oxidation-resistant material, the composite conductor 10 may be built up symmetrically, such that a permutation of both terminal sides 18, 20 is possible without risk.

FIG. 2 shows schematically in a longitudinal cross-section an ending 18, 20 of a composite conductor 10, wherein at the ending 18 or 20, respectively, a seal 28 is arranged between jacket 14 and core 12.

FIG. 3 shows schematically in a longitudinal cross-section the build of a composite conductor 10, wherein its jacket 14 encloses the core 12 gas-tightly (like a glass ampulla fused at its endings).

FIG. 4 shows schematically in a longitudinal cross-section along section line A-A of FIG. 3 the build of an electrical terminal and mechanical holder 36 of the composite conductor 10, wherein its jacket 14 encloses the core 12 gas-tightly. Hereby, the composite conductor 10 is clamped to its jacket 14 by the spring force of a terminal clamp 38. The terminal clamp 38 may be at least one of screwed to a connection lug 40 and welded with a connection lug 40.

For avoiding thermal losses and for obtaining a high as possible overall efficiency, the composite conductor 10 shall have a low as possible heat conductivity along the whole length between its both terminals 42, 44.

FIG. 5 shows schematically a flow of a manufacturing method 100 for the composite conductor 10. Step 110 is the method step of providing the core 12 of a first material; and step 120 is the method step of encasing the core 12 by a second material having a lower electrical conductivity than the first material, wherein the second material is oxidation-resistant at temperatures up to at least 600° C., in particular at temperatures up to at least 800° C., in particular at temperatures up to at least 900° C.

The features disclosed in the preceding description, in the drawings, and in the claims may be essential for performing the invention as well separately as well as in any combination.

### LIST OF REFERENCES

10 composite conductor
12 core
14 jacket
15 inner diameter of the jacket 14
16 lateral surface(s) of the core 12
17 outer diameter of the core 12
18 first ending of the composite conductor 10
20 second ending of the composite conductor 10
22 gap; expansion gap
24 first welding seam at the first ending 18
26 second welding seam at the second ending 20
28 seal
30 length of the core 12
32 length of the jacket 14
34 surrounding of the composite conductor 10
36 electrical terminal; mechanical holder
38 terminal clamp
40 terminal lug
42 first end sleeve
44 second end sleeve
46 bellow
100 manufacturing method for composite conductors 10
110 step of providing the core 12 of the composite conductor 10
120 step of encasing the core 12

1. Composite conductor for electric current, wherein the composite conductor comprises:
a core made of a first material; and
a jacket made of a second material, wherein the second material has a lower electrical conductivity than the first material, the second material is oxidation-resistant at temperatures up to at least 600° C.

2. The composite conductor of claim 1, wherein the second material is oxidation-resistant at temperatures up to at least 800° C.

3. The composite conductor of claim 1, wherein the second material is oxidation-resistant at temperatures up to at least 900° C.

4. The composite conductor of claim 1, further comprising a gas-filled gap arranged at least sectionally between the core and the jacket.

5. The composite conductor of claim 4, wherein the gas-filled gap is arranged along a prevailing portion of the length of the core.

6. The composite conductor of claim 1, wherein the second material comprises a temperature-resistant steel alloy.

7. The composite conductor of claim 1, wherein the second material comprises a temperature-resistant nickel-based alloy.

8. The composite conductor of claim 1, wherein the second material comprises X15CrNiSi25-20.

9. The composite conductor of claim 1, characterized in that the second material comprises X1CrTiLa22.

10. The composite conductor of claim 1, characterized in that the second material comprises NiCr15Fe.

11. The composite conductor of claim 1, wherein the second material is a ceramic.

12. The composite conductor of claim 11, wherein the second material is aluminium oxide.

13. The composite conductor of claim 11, wherein the second material is zirconium oxide.

14. The composite conductor of claim 1, wherein the first material comprises a semiconductor.

15. The composite conductor of claim 14, wherein the first material further comprises a metal alloy.

16. The composite conductor of claim 14, wherein the first material comprises a metal.

17. The composite conductor of claim 16, wherein the metal is copper.

18. The composite conductor of claim 16, wherein the metal is nickel.

19. The composite conductor of claim 16, wherein the metal is silver.

20. The composite conductor of claim 1, wherein the core is substantially air-tightly confined with help of said jacket.

21. The composite conductor of claim 18, wherein the composite conductor is completely enclosed in the jacket.

22. The composite conductor of the claim 1, wherein the core is freely accessible at one ending of the composite conductor.

23. The composite conductor claim 1, wherein at least one of the endings of the jacket, a seal is arranged between the jacket and the core, in particular the seal at the first ending of the composite conductor is a high-temperature-resistant seal.

24. The composite conductor of claim 1, wherein at least one of the endings of the jacket, a seal is arranged between the jacket and the core, in particular wherein the seal at the second ending of the composite conductor is also a high-temperature-resistant seal.

25. The composite conductor of claim 1, wherein at least one of the endings of the jacket, a seal is arranged between the jacket and the core, in particular wherein the seal is made of silicone.

26. The composite conductor of claim 1, wherein at least one of the endings of the jacket, a seal is arranged between the jacket and the core, in particular wherein the seal is made of rubber.

27. The composite conductor of claim 1, wherein the composite conductor is enclosed air-tightly at a first ending of the composite conductor by a first end sleeve made of a third material.

28. The composite conductor of claim 27, wherein the composite conductor is enclosed air-tightly at a second ending of the composite conductor by a second end sleeve made of a fourth material.

29. The composite conductor of claim 28, wherein the fourth material belongs to the group of materials of the first material.

30. Composite conductor of claim 29, wherein the fourth and the first materials are equal.

31. The composite conductor of claim 28, wherein at least one of the third and fourth materials belongs to the group of materials of the second material and wherein the second and third materials are equal.

32. The composite conductor of claim 28, wherein at least one of the third and fourth materials belongs to the group of materials of the second material, and wherein the second and fourth materials are equal.

33. The composite conductor of claim 28, wherein at least one of the third and fourth materials belongs to the group of materials of the second material, and wherein the third and fourth materials are equal.

34. The composite conductor of claim 27, wherein at least one ending of the composite conductor the respective end sleeve is connected to the jacket by at least one of welding, rolling over, and grouting.

35. The composite conductor of claim 27, wherein at least one ending of the composite conductor the respective end sleeve is connected to the core by at least one of welding, rolling over, and grouting.

36. The composite conductor of claim 1, wherein the composite conductor including its terminals do not have any end sleeve.

37. The composite conductor of claim 1, wherein the jacket is joined to the core at least one ending by at least one of welding, rolling over, and grouting.

38. A fuel cell system having at least one fuel cell, wherein the fuel cell system is characterized in that a composite conductor of claim 1 is connected to the at least one fuel cell.

39. A manufacturing method for a composite conductor, wherein the manufacturing method comprises following steps:
Providing a core made of a first material;
Encasing the core by a second material having a lower electrical conductivity than the first material;
wherein the second material is oxidation-resistant at temperatures up to at least 600° C.

40. The manufacturing method of claim 39, wherein the second material is oxidation-resistant at temperatures up to at least 800° C.

41. The manufacturing method of claim 39, wherein the second material is oxidation-resistant at temperatures up to at least 900° C.

42. The manufacturing of claim 39, wherein when encasing the core, a gas-filled gap is left at least sectionally between the core and the jacket.

43. The manufacturing method of claim 39, wherein when encasing the core, a gas-filled gap is left at least sectionally between the core and along a prevailing portion of the length of the core.

44. The manufacturing method of claim 39 or, wherein after the step of encasing the core, the jacket is joined to the core at least one endings ending of the composite conductor by at least one of welding, rolling over, and grouting.

45. The manufacturing method of claim 39, wherein after the step of encasing the core, at least one ending of the composite conductor a respective end sleeve is joined to the jacket by at least one of welding, rolling over, and grouting.

46. The manufacturing method of claim 39, wherein after the step of encasing the core, at least one ending of the composite conductor, a respective end sleeve is joined to the core by at least one of welding, rolling over, and grouting.
